(19) United States
(12) Patent Application Publication
(10) Pub. No.: US 2015/0150307 A1
(43) Pub. Date: Jun. 4, 2015

(54) ELECTRONIC CIGARETTE

(71) Applicant: KIMREE HI-TECH INC., Tortola (VG)

(72) Inventor: Qiuming Liu, Huizhou City (CN)

(21) Appl. No.: 14/412,428

(22) PCT Filed: Apr. 16, 2013
(86) PCT No.: PCT/CN2013/074248

§ 371 Date: Dec. 31, 2014

(30) Foreign Application Priority Data
Dec. 11, 2012 (CN) PCTCN2012086367

(51) Int. Cl. A24F 47/00; H05B 1/02

(52) U.S. Cl. CPC A24F 47/008; H05B 1/0244

(57) ABSTRACT

An electronic cigarette comprises an atomizer (22) provided with a heating wire (221), and a battery (30) electrically connected to the atomizer (22) for providing power for the atomizer (22). A first electrode component (40) electrically connected to the atomizer (22) and an anode and a cathode of the battery (30) respectively is arranged between the atomizer (22) and the battery (30). The first electrode component (40) comprises a first electrode part (41) directly facing a first electrode (31) of the battery (30). A first elastic contact part is arranged between the first electrode (31) of the battery and the first electrode part (41), and the first electrode of the battery and the first electrode part are electrically connected through the first elastic contact part. The battery (30) of the electronic cigarette is electrically connected to the electrode part and a control switch (50) of the atomizer directly through the elastic contact part, a process is simple, and reliability is high.

### FIELD OF THE INVENTION

The present invention relates to electronic cigarettes, especially to an electronic cigarette, in which a positive electrode and a negative electrode of a battery electrically connected with corresponding electrodes of an atomizer and an atomizer control switch by elastic contact pieces.

### BACKGROUND OF THE INVENTION

Conventional electronic cigarette includes an atomizer, a battery and an atomizer control switch which are disposed in a main rod body and mutually electrically connected. Usually, a positive electrode and a negative electrode of the battery are respectively disposed at two ends of the battery. The atomizer is disposed at one end of the battery and electrically connected to corresponding electrodes of the battery by electrode pieces. The battery and the electrode pieces of conventional electronic cigarette adopt the way of welding to achieve electrical connection. Since the main rod body of the electronic cigarette is slender and long, so it is required that welding process is very high. Complex processing technology will undoubtedly result in increased processing cost, and because the reliability of welding is not high, there are problems such as short circuit, poor contact, even unable to be conducted and so on. Meanwhile, the atomizer control switch is usually welded to the corresponding electrodes of the battery by wire, the aforementioned problems also exist.

### SUMMARY OF THE INVENTION

The problem to be solved by the present invention is to provide an electronic cigarette, in which connection and assembly process of a battery are simple, and electrical connection is more reliable and safer.

To solve the above-mentioned problem, the present invention provides an electronic cigarette including an atomizer provided with a heating wire and a battery electrically connected with the atomizer to supply power for the atomizer. Between the atomizer and the battery disposes a first electrode assembly respectively connecting with positive and negative electrodes of the atomizer and the battery. The first electrode assembly comprises a first electrode piece facing to a first electrode of the battery. Between the first electrode of the battery and the first electrode piece disposes a first elastic contact piece to achieve electrical connection of the first electrode of the battery and the first electrode piece by the first elastic contact piece.

Furthermore, the first elastic contact piece is a first compression spring; one end of the first electrode piece facing to the battery extends toward the battery to form a first convex column operable to fix the first compression spring.

Furthermore, the first elastic contact piece is a first elastic plate; the first elastic plate and the first electrode piece are disposed to be connected by welding or clamping.

Furthermore, one end of the battery away from the atomizer disposes an atomizer control switch; the atomizer control switch electrically connects with the corresponding electrodes of the atomizer and the battery respectively to control the power on or power off of the atomizer; the atomizer control switch faces a second electrode of the battery; between the second electrode of the battery and the atomizer control switch disposes a second elastic contact piece to achieve electrically connection of the second electrode of the battery and the atomizer control switch by the second elastic contact piece.

Furthermore, the second elastic contact piece is a second compression spring; one end of the atomizer control switch opposite to the battery extends toward the battery to from a second convex column operable to fix the second compression spring.

Furthermore, the second elastic contact piece is a second elastic plate; the second elastic plate and the atomizer control switch are disposed to be connected by welding or clamping.

Furthermore, the electronic cigarette further comprises a main rod body of which internal is hollow; the first electrode piece is supported and fixed in the main rod body by a first fixing seat.

Furthermore, a central of the first fixing seat has a first fixing hole longitudinally running through a top wall and a bottom wall thereof; the first electrode piece is fixed in the first fixing hole; an inner wall of the first fixing hole radially extends inward the first fixing hole to form a first convex edge; an outer wall of the first electrode piece corresponding to the first convex edge disposes a first latching slot being concave.

Furthermore, the first fixing seat is made of conductive material and is mutually insulated from the first electrode piece; the first fixing seat is electrically connected with the atomizer control switch.

Furthermore, the main rod body comprises a battery rod and an inhalation rod which are mutually abutted; the battery is disposed in the battery rod; the atomizer is disposed in the inhalation rod; one end of the inhalation rod abutting with the battery rod corresponding to the first electrode assembly disposes a second electrode assembly.

Furthermore, the second electrode assembly comprises a second electrode piece and a second fixing seat; both the second electrode piece and the second fixing seat are made of conductive material and mutually insulated from each other; the second electrode piece connects with and a first end of the heating wire to form a first electrode of the atomizer; the second fixing seat connects with a second end of the heating wire to form a second electrode of the atomizer; the second electrode piece and the second fixing seat are matchingly abutted with the first electrode piece and the first fixing seat respectively.

Furthermore, a central of the second fixing seat defines a second fixing hole longitudinally running through a top wall and a bottom wall; the second electrode piece is fixed in the second fixing hole; an inner wall of the second fixing hole radially extends inward the second fixing hole to form a second convex edge; an outer wall of the second electrode piece corresponding to the second convex edge disposes a second latching slot being concave.

Furthermore, facing ends of the battery rod and the inhalation rod correspondingly dispose a first connection member and a second connection member which are mutually matched; the first fixing seat is disposed at end portion of one end of the battery rod abutting to the inhalation rod and forms the first connection member; the second fixing seat is disposed at end portion of one end of the inhalation rod abutting to the battery rod and forms the second connection member.

Furthermore, one end of the first fixing seat toward the second fixing seat disposes a fixing groove for a corresponding end of the second fixing seat to be inserted and fixed in the second fixing seat; one end of the second fixing seat being inserted in the first fixing seat disposes a boss fitting with an inner contour of the fixing groove to be clamped in the fixing groove.

Furthermore, end portion of one end of the main rod body corresponding to the atomizer control switch disposes a cover body; the atomizer control switch is fixed on the cover body.

The advantage of the embodiment of the present invention are: by disposing a first elastic contact piece between the first electrode of the battery and the first electrode piece, and disposing a second elastic contact piece between the battery and the atomizer control switch, achieves electrical connection among the battery, the atomizer and the atomizer control switch by the elastic abutting; the processing technology is simple, and with high reliability.

Embodiments of the present invention will be further described in detail in the following drawings.

### BRIEF DESCRIPTION OF THE DRAWINGS

FIG. 1 is a perspective view of an electronic cigarette according to a first embodiment of the present invention.

FIG. 2 is a sectional structural schematic view of the electronic cigarette according to the first embodiment of the present invention.

FIG. 3 is a perspective view of an electronic cigarette according to a second embodiment of the present invention.

FIG. 4 is an exploded, isometric view of the electronic cigarette according to the second embodiment of the present invention.

FIG. 5 is a sectional structural schematic view of the electronic cigarette according to the second embodiment of the present invention.

FIG. 6 is a sectional structural schematic view of a battery rod of the electronic cigarette according to the second embodiment of the present invention.

FIG. 7 is a perspective view of a first electrode piece of the electronic cigarette according to an embodiment of the present invention.

FIG. 8 is a sectional structural schematic view of an inhalation rod of the electronic cigarette according to the second embodiment of the present invention.

### DETAILED DESCRIPTION OF THE INVENTION

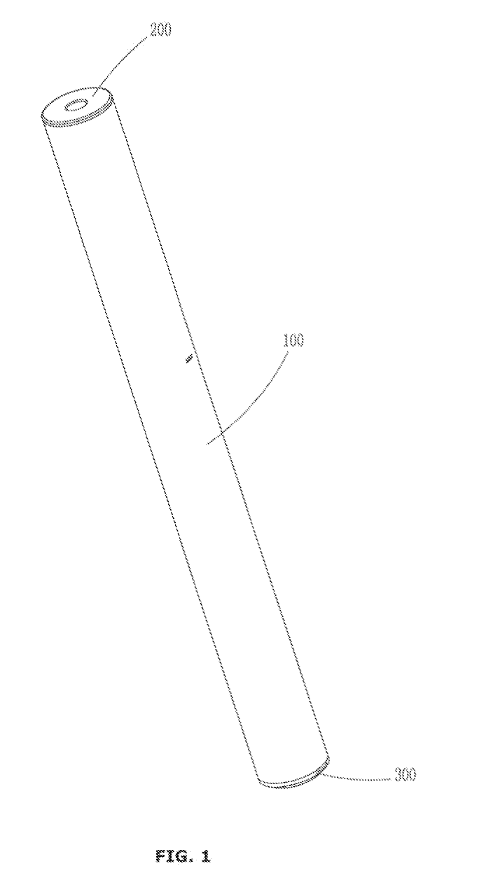

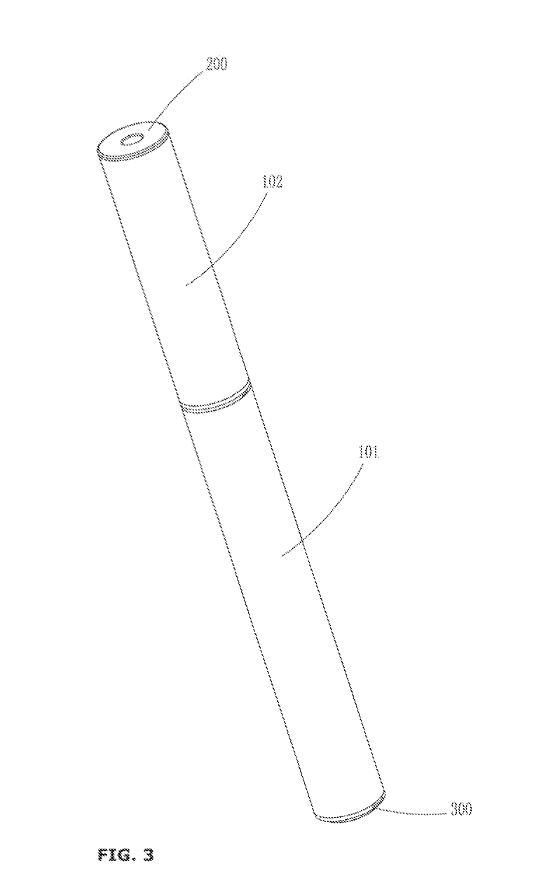

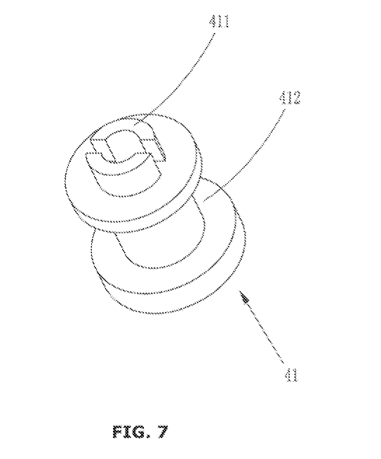

Referring to FIG. 1 to FIG. 8, an embodiment of the present invention provides an electronic cigarette, including a main rod body 100 and various internal components disposed in the main rod body 100.

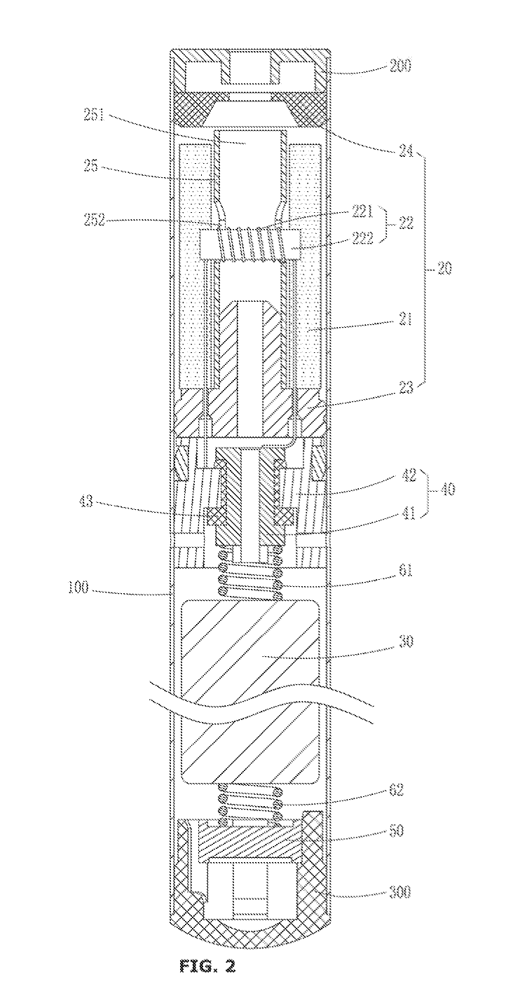

Referring to FIG. 2, an internal of the main rod body 100 is hollow to form accommodating chambers for the various internal components, and the shape of the main rod body 100 is preferably disposed as tube structure with a circular cross-section same to a shape of real cigarette to strengthen simulation of the electronic cigarette. Certainly, the main rod body 100 also may be disposed as cylindrical structure with the cross-section being polygonal or other combined shape according to design needs to enrich the external shape of the electronic cigarette. In the embodiment, the main rod body 100 specifically may be made of materials such as metal, plastic, paper, wood and etc., and an outer surface of the main rod body 100 also may be pasted a sticker printed with a real cigarette pattern to further improve simulation of the electronic cigarette and enhance hand feeling.

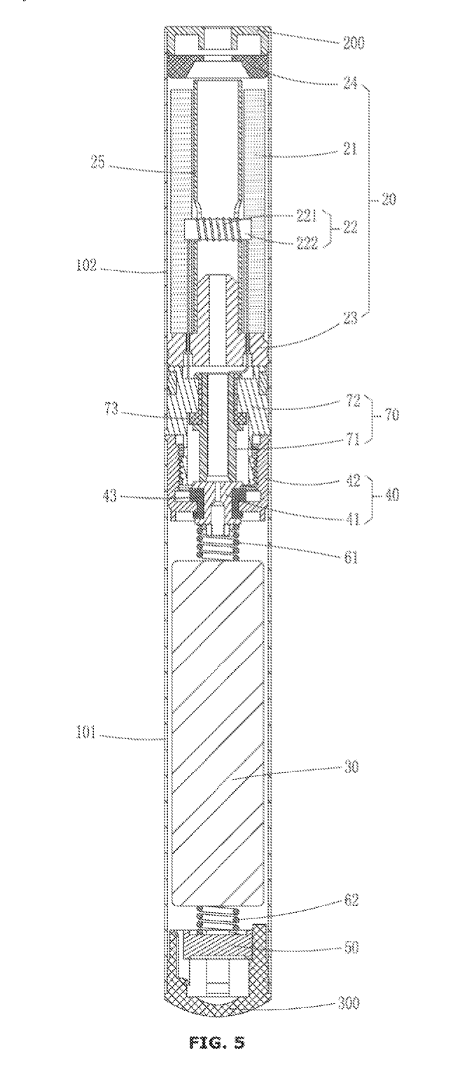

Referring to FIG. 2 and FIG. 5, the main rod body 100 disposes an atomization device 20 and a battery 30 therein. The atomization device 20 is used to vaporize e-liquid to aerosol for users smoking. The battery 30 electrically connects with the atomization device 20 to supply power to the atomization device 20.

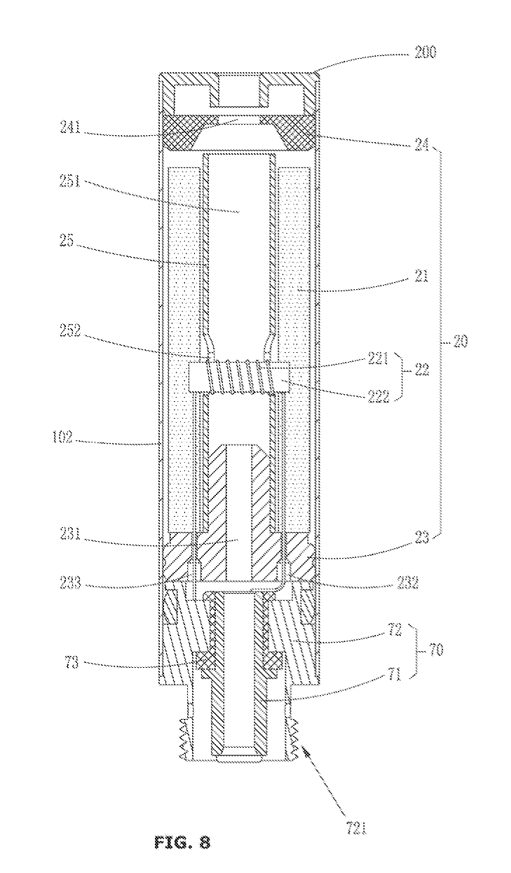

Referring to FIG. 8, the atomization device 20 includes a liquid-storage member 21, an atomizer 22, an atomization seat 23 and an atomization cover 24.

The liquid-storage member 21 is capable of absorbing and storing e-liquid, therefore is used to absorb and store e-liquid to facilitate the atomizer 22 to vaporize the e-liquid subsequently. In the embodiment, the liquid-storage member 21 may be made of materials capable of absorbing and storing liquid such as fiberglass, non-woven fabric, wood pulp fiber, chemical fiber, polyvinyl alcohol, high temperature cotton, chemical fiber cotton, mixed cotton, liquid-absorbing cotton, nickel foam and etc.

In the embodiment, the liquid-storage member 21 is disposed as hollow tube structure to match with the main rod body 100, and coaxially disposed with main rod body 100.

Continuing referring to FIG. 8, in the embodiment, the liquid-storage member 21 is supported and fixed between the atomization seat 23 and the atomization cover 24 by a supporting tube 25. The central of the supporting tube 25 forms an atomization chamber 251 operable to conduct air path and accommodate the atomizer 22.

The atomizer 22 is used to vaporize e-liquid to aerosol. In the embodiment, the atomizer 22 is composed of a heating wire 221 and an atomization rod 222. The heating wire 221 winds on the atomization rod 222. The atomization rod 222 is supported and fixed in an internal of the liquid-storage member 21 to absorb the e-liquid in the liquid-storage member 21 for the heating wire 21 to heat and vaporize the e-liquid.

In the embodiment, the atomization rod 222 is disposed as cylindrical shape, and may be made of fiberglass or other high temperature resistance fiber materials capable of absorbing liquid.

The atomization rod 222 is radially disposed in the supporting tube 25. On a sidewall of the supporting tube 25 correspondingly defines a latching opening 252 radially through the sidewall. Two ends of the atomization rod 222 extend out of the supporting tube 25 from the latching opening 252 and abut with an inner wall of the liquid-storage member 21, then absorb the e-liquid in the liquid-storage member 21 to supply the heating wire 221 to heat and vaporize. When specifically disposed, in order to avoid the atomization rod 222 axially moving in the supporting tube 25, an external of the supporting tube 25 may further be sheathed with a positioning tube disposed above or below the atomization rod 222.

Since temperature of the heating wire 221 is high when power on and vaporizing e-liquid, and to enhance service life and heat resistance of the liquid-storage member 21, in the embodiment, between the liquid-storage member 21 and the supporting tube 25 may be further sheathed with a heat-insulation member which is made of materials capable of high temperature resistance and absorbing liquid, to enhance the protection of the liquid-storage member 21.

In the embodiment, both the atomization seat 23 and the atomization cover 24 are made of rubber materials capable of having a certain elastic deformation such as silicone, and an outer contour of the atomization seat 23 and the atomization cover 24 matches with an inner contour of the main rod body 100 and preferably disposed as interference fit. Both the atomization seat 23 and the atomization cover 24 are tensioningly fixed in the main rod body 100 by using outer walls thereof to make the liquid-storage member 21 hermetically fixed in the main rod body 100. Referring to FIG. 8, a central of the atomization seat 23 and the atomization cover 24 correspondingly disposes a first air vent 231 and a second air vent 241 respectively to communicate with the atomization chamber 251 to conduct the air path. Meanwhile, a sidewall of the atomization seat 23 further axially defines a first threading hole 232 and a second threading hole 233 respectively for two ends of the heating wire 221 passing through.

Referring to FIG. 2 and FIG. 5, between the atomization device 20 and the battery 30 disposes a first electrode assembly 40. The first electrode assembly 40 electrically connects with positive and negative electrodes of the atomizer 22 and the battery 30 respectively, thus to achieve electrical connection between the atomizer 22 and the battery 30. One end of the battery 30 away from the atomizer 22 disposes an atomizer control switch 50. The atomizer control switch 50 electrically connects with the corresponding electrodes of the atomizer 22 and the battery 30 respectively to control the power on or power off of the atomizer 22.

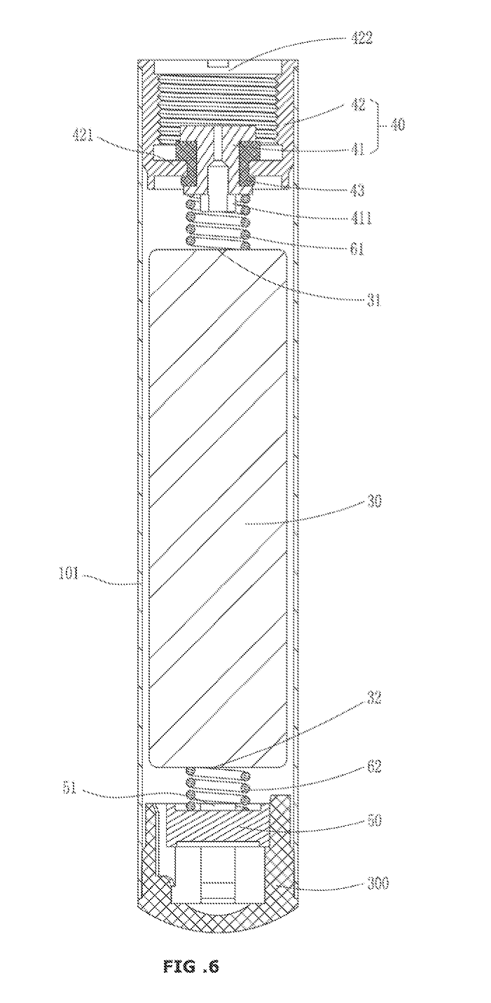

Referring to FIG. 6, the positive and negative electrodes of the battery 30 are respectively disposed at two opposite ends of the battery 30. The first electrode assembly 40 includes a first electrode piece 41. The first electrode piece 41 faces a first electrode 31 of the battery 30. Between the first electrode 31 of the battery 30 and the first electrode piece 41 disposes a first elastic contact piece to achieve electrical connection of the first electrode 31 of the battery 30 and the first electrode piece 41 by the first elastic contact piece.

In the embodiment, the first elastic contact piece is specifically disposed as a first compression spring 61. The battery 30 elastically abuts with the first electrode piece 41 by the first compression spring 61 to achieve electrically connect with the first electrode piece 41 by the first compression spring 61. In order to preferably firm the first compression spring 61, one end of the first electrode piece 41 facing to the battery 30 extends toward the battery 30 to from a first convex column 411 operable to fix the first compression spring 61. As an alternative embodiment, the first elastic contact piece may also be disposed as a first elastic plate (not shown). The first elastic plate and the first electrode piece 41 may be disposed to be connected by welding, clamping and etc.

In the embodiment, the first electrode piece 41 is supported and fixed in the main rod body 100 by a first fixing seat 42. Specifically, referring to FIG. 6, the first fixing seat 42 is tensioningly fixed in the main rod body 100, and a central of the first fixing seat 42 has a first fixing hole longitudinally running through a top wall and a bottom wall thereof. The first electrode piece 41 is accommodated in the first fixing hole. An inner wall of the first fixing hole radially extends inward the first fixing hole to form a first convex edge 421. An outer wall of the first electrode piece 41 corresponding to the first convex edge 421 disposes a first latching slot 412 which is concave.

In the embodiment, the first fixing seat 42 is made of conductive material, which is electrically connected with the atomizer control switch 50 to achieve conduction of the circuit, and is mutually insulated from the first electrode piece 41 by a first insulation sleeve 43.

The atomizer control switch 50 faces a second electrode 32 of the battery 30. Between the second electrode 32 of the battery 30 and the atomizer control switch 50 disposes a second elastic contact piece. Continue referring to FIG. 6, in the embodiment, the second elastic contact piece is specifically disposed as a second compression spring 62. One end of the atomizer control switch 50 facing to the battery 30 extends toward the battery 30 to form a second convex column 51 operable to fix the second compression spring 62. As an alternative embodiment, the second elastic contact piece also may be disposed as a second elastic plate. The second elastic plate and the atomizer control switch 50 may be disposed to be connected by welding, clamping and etc.

Referring to FIG. 1 to FIG. 5, end portion of one end of the main rod body 100 adjacent to the atomization device 20 disposes a mouthpiece 200, and end portion of one end near the atomizer control switch 50 disposes a cover body 300 to encapsulate the electronic cigarette. The atomizer control switch 50 is fixed on the cover body 300. In the embodiment, the atomizer control switch 50 may be disposed as a capacitive sensor switch, or be disposed as an airflow sensor switch, and or be disposed as a traditional key switch.

The cover body 300 is further fixed with a light-emitting unit which is electrically connected with the atomizer control switch 50. The light-emitting unit is controlled by the atomizer control switch 50 to turn on or turn off. In the embodiment, the light-emitting unit is disposed as a red emitting light, and then when users smoking the electronic cigarette, one end of the electronic cigarette away from the mouthpiece 200 forms a red light aperture similar to that of a real cigarette burning, and then improves the reality of visual sense for users. In order to make light of the light-emitting unit can be projected out, the whole or at least end surface of the cover body 300 is disposed as transparent or semitransparent. In the embodiment, the whole of the cover body 300 is made of transparent plastic material.

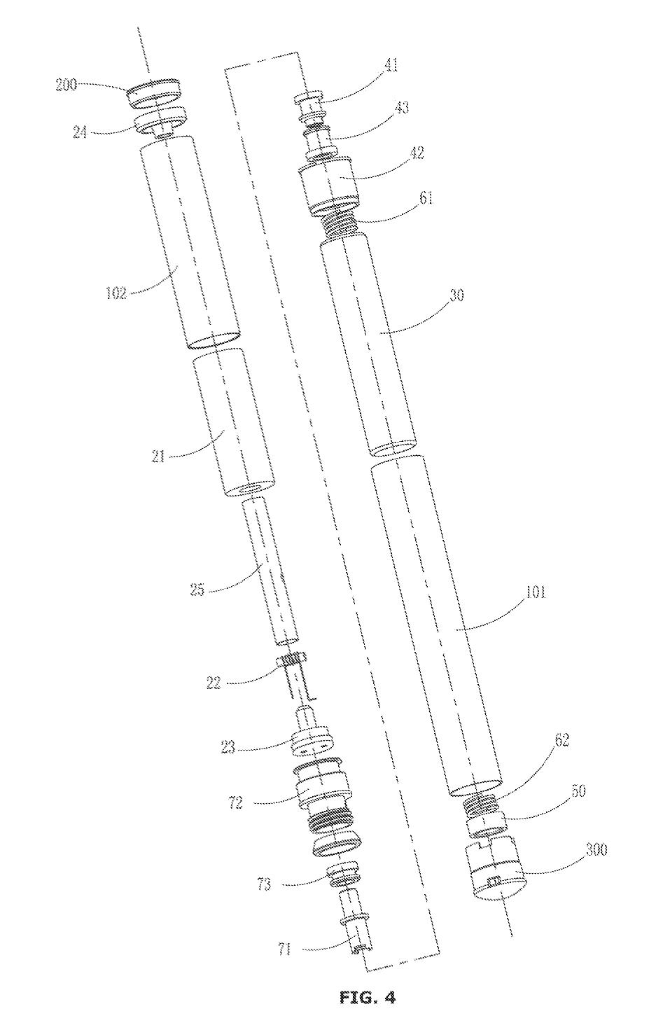

Referring to FIG. 4 and FIG. 5, in the embodiment, the main rod body 100 also may be disposed as separate structure formed by matching and abutting of a battery rod 101 and an inhalation rod 102. The battery 30 is disposed in the battery rod 101. The atomizer 22 is disposed in the inhalation rod 102. One end of the inhalation rod 102 abutting with the battery rod 101 corresponding to the first electrode assembly 40 disposes a second electrode assembly 70 which is matching and electrically connected with the first electrode assembly 40.

The second electrode assembly 70 includes a second electrode piece 71 and a second fixing seat 72. Both the second electrode piece 71 and the second fixing seat 72 are made of conductive material, and insulation between the second electrode piece 71 and the second fixing seat 72 is achieved by a second insulation ring 73. In the embodiment, the second electrode piece 71 connects with a first end of the heating wire 221 to form a first electrode of the atomizer 22. The second fixing seat 72 connects with a second end of the heating wire 221 to form a second electrode of the atomizer 22. The second electrode piece 71 and the second fixing seat 72 are matching and electrically connected with the first electrode piece 41 and the first fixing seat 42 respectively.

In the embodiment, a structure of the second electrode assembly 70 and the structure of the first electrode assembly 40 are basically the same, that is, a central of the second fixing seat 72 defines a second fixing hole longitudinally running through a top wall and a bottom wall thereof. The second electrode piece 71 is accommodated and fixed in the second fixing hole. An inner wall of the second fixing hole radially extends inward the second fixing hole to form a second convex edge. An outer wall of the second electrode piece 71 corresponding to the second convex edge disposes a second latching slot which is concave. A second insulation ring 73 is clamped and embedded between the second convex edge and the second latching slot.

In order to make the battery rod 101 and the inhalation rod 102 be securely abutted, facing ends of the battery rod 101 and the inhalation rod 102 correspondingly dispose a first connection member and a second connection member which are mutually matched. In the embodiment, the first fixing seat 42 is disposed at end portion of one end of the battery rod 101 abutting to the inhalation rod 102 and forms the first connection member. The second fixing seat 72 is disposed at end portion of one end of the inhalation rod 102 abutting to the battery rod 101 and forms the second connection member.

Specifically, referring to FIG. 6 and FIG. 8, one end of the first fixing seat 42 toward the second fixing seat 72 disposes a fixing groove 422 for a corresponding end of the second fixing seat 72 being inserted and fixed in the second fixing seat 72. One end of the second fixing seat 72 being inserted in the first fixing seat 42 disposes a boss 721 fitting with an inner contour of the fixing groove 422 to be inserted in the fixing groove 422. An inner sidewall of the fixing groove 422 and an outer sidewall of the boss 721 correspondingly dispose mutually matched threads to achieve matching and abutting between the inhalation rod 102 and the battery rod 101 by thread connection. As an alternative embodiment, the fixing groove 422 also may be disposed at the corresponding end of the second fixing seat 72, while the corresponding end corresponding to the first fixing seat 42 disposes the boss 721 to insert in the fixing groove 422. Meanwhile, the connection between the first fixing seat 42 and the second fixing seat 72 also may be disposed as clamping, inserting, magnetic connection and other connections.

It is understood that, the electronic cigarette of the embodiment of the present invention is not limit to the embodiments shown in FIG. 1 to FIG. 8, therein various technical features from embodiments may be combined to form new embodiments.

Embodiments of the present invention is shown and described in the above-mentioned. Various improvement and modifications can be made to the embodiments by those skilled in the art without departing from the true spirit and scope of the disclosure. The scope of the present invention is defined by the appended claims and equivalents thereof.

What is claimed is:

1. An electronic cigarette, comprising an atomizer provided with a heating wire and a battery electrically connected with the atomizer to supply power for the atomizer; wherein between the atomizer and the battery disposes a first electrode assembly respectively connecting with positive and negative electrodes of the atomizer and the battery; the first electrode assembly comprises a first electrode piece facing to a first electrode of the battery; between the first electrode of the battery and the first electrode piece disposes a first elastic contact piece, to achieve electrically connected between the first electrode of the battery and the first electrode piece by the first elastic contact piece.

2. According to the electronic cigarette in claim 1, wherein the first elastic contact piece is a first compression spring; one end of the first electrode piece facing to the battery extends toward the battery to form a first convex column operable to fix the first compression spring.

3. According to the electronic cigarette in claim 1, wherein the first elastic contact piece is a first elastic plate; the first elastic plate and the first electrode piece are disposed to be connected by welding or clamping.

4. According to the electronic cigarette in claim 1, wherein one end of the battery away from the atomizer disposes an atomizer control switch; the atomizer control switch electrically connects with the corresponding electrodes of the atomizer and the battery respectively to control the power on or power off of the atomizer; the atomizer control switch faces a second electrode of the battery; between the second electrode of the battery and the atomizer control switch disposes a second elastic contact piece to achieve electrically connection of the second electrode of the battery and the atomizer control switch by the second elastic contact piece.

5. According to the electronic cigarette in claim 4, wherein the second elastic contact piece is a second compression spring; one end of the atomizer control switch opposite to the battery extends toward the battery to form a second convex column operable to fix the second compression spring.

6. According to the electronic cigarette in claim 4, wherein the second elastic contact piece is a second elastic plate; the second elastic plate and the atomizer control switch are disposed to be connected by welding or clamping.

7. According to the electronic cigarette in claim 4, wherein the electronic cigarette further comprises a main rod body of which internal is hollow; the first electrode piece is supported and fixed in the main rod body by a first fixing seat.

8. According to the electronic cigarette in claim 7, wherein a central of the first fixing seat has a first fixing hole longitudinally running through a top wall and a bottom wall thereof; the first electrode piece is fixed in the first fixing hole; an inner wall of the first fixing hole radially extends inward the first fixing hole to form a first convex edge; an outer wall of the first electrode piece corresponding to the first convex edge disposes a first latching slot being concave.

9. According to the electronic cigarette in claim 8, wherein the first fixing seat is made of conductive material and is mutually insulated from the first electrode piece; the first fixing seat is electrically connected with the atomizer control switch.

10. According to the electronic cigarette in claim 9, wherein the main rod body comprises a battery rod and an inhalation rod which are mutually abutted; the battery is disposed in the battery rod; the atomizer is disposed in the inhalation rod; one end of the inhalation rod abutting with the battery rod corresponding to the first electrode assembly disposes a second electrode assembly.

11. According to the electronic cigarette in claim 10, wherein the second electrode assembly comprises a second electrode piece and a second fixing seat; both the second electrode piece and the second fixing seat are made of conductive material and mutually insulated from each other; the second electrode piece connects with and a first end of the heating wire to form a first electrode of the atomizer; the second fixing seat connects with a second end of the heating wire to form a second electrode of the atomizer; the second electrode piece and the second fixing seat are matchingly abutted with the first electrode piece and the first fixing seat respectively.

12. According to the electronic cigarette in claim 11, wherein a central of the second fixing seat defines a second fixing hole longitudinally running through a top wall and a bottom wall; the second electrode piece is fixed in the second fixing hole; an inner wall of the second fixing hole radially extends inward the second fixing hole to form a second convex edge; an outer wall of the second electrode piece corresponding to the second convex edge disposes a second latching slot being concave.

13. According to the electronic cigarette in claim 11, wherein facing ends of the battery rod and the inhalation rod correspondingly dispose a first connection member and a second connection member which are mutually matched; the first fixing seat is disposed at end portion of one end of the battery rod abutting to the inhalation rod and forms the first connection member; the second fixing seat is disposed at end portion of one end of the inhalation rod abutting to the battery rod and forms the second connection member.

14. According to the electronic cigarette in claim 13, wherein one end of the first fixing seat toward the second fixing seat disposes a fixing groove for a corresponding end of the second fixing seat to be inserted and fixed in the second fixing seat; one end of the second fixing seat inserted in the first fixing seat disposes a boss fitting with an inner contour of the fixing groove to be clamped in the fixing groove.

15. According to the electronic cigarette in claim 7, wherein end portion of one end of the main rod body corresponding to the atomizer control switch disposes a cover body; the atomizer control switch is fixed on the cover body.
